(19) United States
(12) Patent Application Publication
(10) Pub. No.: US 2012/0316969 A1
(43) Pub. Date: Dec. 13, 2012

(54) SYSTEM AND METHOD FOR ADVERTISEMENT RANKING AND DISPLAY

(76) Inventor: Otis Rudy METCALF, III, Peculiar, MO (US)

(21) Appl. No.: 13/495,812

(22) Filed: Jun. 13, 2012

Related U.S. Application Data
(60) Provisional application No. 61/496,465, filed on Jun. 13, 2011.

(51) Int. Cl. G06Q 30/02

(52) U.S. Cl. 705/14.66

(57) ABSTRACT

A system in communication with a viewer database having at least one viewer profile. The viewer profile including a plurality of scalars corresponding with preferential demographic data. The system also including an advertisements database having a plurality of scalars associated with advertisement content data and product data. The system further including a process for matching viewers with relevant advertisements by comparing the scalars of the viewer profile with the corresponding scalars of advertisement database data. The system is configured to operationally incorporate viewer behavior to refine a comparison of viewer profiles scalars with advertisement database data scalars.

### CROSS-REFERENCE TO RELATED APPLICATION

This patent application claims the benefit and priority of U.S. Provisional Patent Application Ser. No. 61/496,465 filed Jun. 13, 2011, titled “System And Method for Advertisement Ranking and Display,” the entire contents of which is herein incorporated by reference in its entirety.

### BACKGROUND

1. Field

The present inventive concept relates to a system and process for ranking advertisements for display to a viewer.

2. Related Art

Traditionally a small percentage of a viewing audience watches a given advertisement. An even smaller percentage takes follow-up action on the advertisement such as inquiring for more information or purchasing the product. Some industry measurements consider a positive reception, i.e. the percentage of people actually viewing the advertisement, to be in the single digits. Some of the most commonly cited reasons for such a low percentage are that the product is not relevant to the viewing audience or that the theme or topic does not resonate with the viewing audience. Traditional advertisement campaigns have attempted to use approaches such as focus grouping to address the problem. However that approach suffers because the desired demographic for a given product is still a small percentage of viewers of a traditional broadcast medium. Attempts to address the lack of personal relevance of online advertisements have involved scanning keywords of current online activity to generate advertisements, or large scale aggregate “upvoting” or “downvoting” of advertisements, but single digit percentage click-through rates are still the norm. It would be advantageous to provide a system and process that seeks to improve, inter alia, the level of personal relevance to and/or the average attentiveness exhibited by viewers of advertisements.

### SUMMARY

The following brief description is provided to indicate the nature of the subject matter disclosed herein. While certain aspects of the present inventive concept are described below, the summary is not intended to limit the scope of the present inventive concept.

The system includes a viewer database having a plurality of viewer profiles, each viewer profile having a plurality of scalars corresponding with elements of preferential demographic data. The system also includes a database of advertisements having a plurality of scalars associated with elements of the advertisement content data and product data. The system further includes a process for matching viewers with advertisements by comparing the scalars of the viewer profile with the corresponding scalars of the advertisement data. The system is preferably also configured to process data relating to viewer behavior to refine the comparison of viewer profile scalars with advertisement data scalars.

The aforementioned may be achieved in one aspect of the present inventive concept by providing a method of delivering one or more mandatory advertisements for presentation to a viewer, including generating a data set by comparing information associated with a viewer profile of the viewer to information associated with a plurality of advertisements, selecting one or more mandatory advertisements from among the plurality of advertisements based on the data set, populating a viewer queue with the one or more mandatory advertisements, and delivering the one or more mandatory advertisements to the viewer. The information associated with the plurality of advertisements might include information regarding characteristics of at least one of the plurality of advertisements, a product or service associated with at least one of the plurality of advertisements, preferences of at least one advertiser associated with at least one of the plurality of advertisements, or preferences of at least one user of the system.

The information associated with the viewer profile might include a preference demographic scalar, and be compared against an advertisement scalar associated with the advertisements. The information associated with the advertisements might also be a product scalar, or target viewer demographics, such as those relating to age, income, or sex. The advertisements might also be associated with parameters for comparison against the viewer profile, such as parameters requiring viewers to be within a certain geographic zone. Further, the information associated with the advertisements might be normalized based on other advertisements in the system, such as those with common themes.

The viewer may also be allowed to choose a product of interest which might also be compared with information associated with advertisements in relation to selecting one or more mandatory advertisements. The viewer might also select the product of an advertisement for addition to his/her own wish list or to the wish list of another such as an associated viewer, and may view part or all of associated viewers' wish lists, depending on permissions set by those associated viewers.

The viewer might also be prompted to provide some sort of input to confirm viewing of an advertisement. The system may generate a data-input request and deliver it to the viewer during or following display of an advertisement. The system might also prompt the viewer to input a response to a data-input request relating to the content of an advertisement following display of the advertisement.

The viewer may also be given an option to rate an advertisement. Preferably, rating an advertisement is incentivized by the system accelerating viewing of the next advertisement based on receiving a rating on the first.

The viewer may be provided the option of forwarding advertisements for display to others, whether those others are existing users, such as associated viewers, or not. If not, the viewer may identify the other using an identifier, such as an e-mail address, to identify the person to the viewer or facilitate contact and cause the delivery of the advertisement. The viewer might also be provided the option to send a personalized message along with the advertisement.

The data set used to arrange advertisements and select one or more mandatory advertisements might be adjusted using offsets, which are calculated from recorded viewer behavior data that is collected over time and retrievably stored in the system related to user behavior. Such offsets can be applied to adjust the data set for a more accurate comparison.

Compensation for viewing an advertisement may be calculated following viewing of the advertisement, and may be based upon a determination that a proper entrance event occurred and that advertisement viewing parameters were complied with. Compensation might also be flighted, whether by reducing the amount of compensation or the likelihood of getting compensated as more and more advertisements are viewed by the viewer in any given day.

The viewer might also select a level of relationship or category to place different associated viewers into, and can control access permissions and the like by individual or by relationship level or category. Further, information associated with a viewer profile may be adjusted based on information associated with the viewer profiles of associated viewers. For example, if close associated viewers consistently purchase a certain product, the viewer's information may be adjusted using correlation modifiers derived from such purchasing behavior of associated viewers.

The viewer could also be provided a search tool for searching for advertisements viewable at any time by the viewer, though not necessarily for compensation. The viewer might wish to do so when simply searching for a certain product or looking for a coupon. Coupons may be associated with some or all of the advertisements in the system.

At least a portion of the present general inventive concept may be embodied in a computer readable medium and configured to be executed on one or more computing devices such as a computer, a PDA, a cell phone, a laptop, a computer, a desktop, a gaming console, a television gaming console, a handheld gaming console, a wireless gaming console, a LCD, an iPad, an iPhone, a smart phone, a television, or some other type of computing device.

While the present inventive concept has been described in connection with certain preferred embodiments, other embodiments would be understood by one of ordinary skill in the art and are encompassed herein.

### BRIEF DESCRIPTION OF THE FIGURES

The inventive concept and the following detailed descriptions of certain embodiments thereof may be understood by reference to the following figures:

FIG. 1 depicts a block diagram of an embodiment of the system;

FIG. 2 depicts a flowchart for the process of inputting viewer information into the system of FIG. 1;

FIG. 3 depicts a flowchart for the process of uploading advertisements to the system of FIG. 1;

FIG. 4 depicts a flowchart for the process of populating a viewer queue of the system of FIG. 1;

FIG. 5 depicts a flowchart for the process of refining a data set;

FIG. 6 depicts a flowchart for the process of displaying an advertisement to a viewer of the system of FIG. 1;

FIG. 7 depicts a flowchart for the process of compensating a viewer of a displayed advertisement;

FIG. 8 depicts a flowchart for the process of notifying an associated viewer of an advertisement;

FIG. 9 depicts a flowchart for the process of retrieving an associated viewer's desired product information;

FIG. 10 depicts a flowchart for the process of purchasing a displayed product; and

FIG. 11 depicts a flowchart for the ratings process after viewing an advertisement.

The drawing figures do not limit the present inventive concept to the specific embodiments disclosed and described herein. The drawings are not necessarily to scale, emphasis instead being placed upon clearly illustrating the principles of the present inventive concept.

### DETAILED DESCRIPTION

The following detailed description of the present inventive concept references the accompanying drawings that illustrate specific embodiments in which the present inventive concept can be practiced. The embodiments are intended to describe aspects of the present inventive concept in sufficient detail to enable those skilled in the art to practice the present inventive concept. Other embodiments can be utilized and changes can be made without departing from the scope of the present inventive concept. The following detailed description is, therefore, not to be taken in a limiting sense. The scope of the present inventive concept is defined only by the appended claims, along with the full scope of equivalents to which such claims are entitled.

In this description, references to “exemplary embodiment,” “one embodiment,” “an embodiment,” or “embodiments” mean that the feature or features being referred to are included in at least one embodiment of the technology. Separate references to “exemplary embodiment,” “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

The terms “a” or “an,” as used herein, are defined as one or more than one. The term “another,” as used herein, is defined as at least a second or more. The terms “including” and/or “having” as used herein, are defined as comprising, i.e., open transition. The term “coupled” as used herein, is defined as indirectly or directly connected. The term system “user” may be a viewer, an administrator, an advertiser, or other entity involved in operation or use of the system disclosed herein. The term “viewed or view” in relation to an advertisement refers to the act of playback or review of the advertisement, for example viewing and listening to an audiovisual advertisement, listening to an audio advertisement, or viewing a print advertisement. The term “product” in relation to content of an advertisement refers to a product or service.

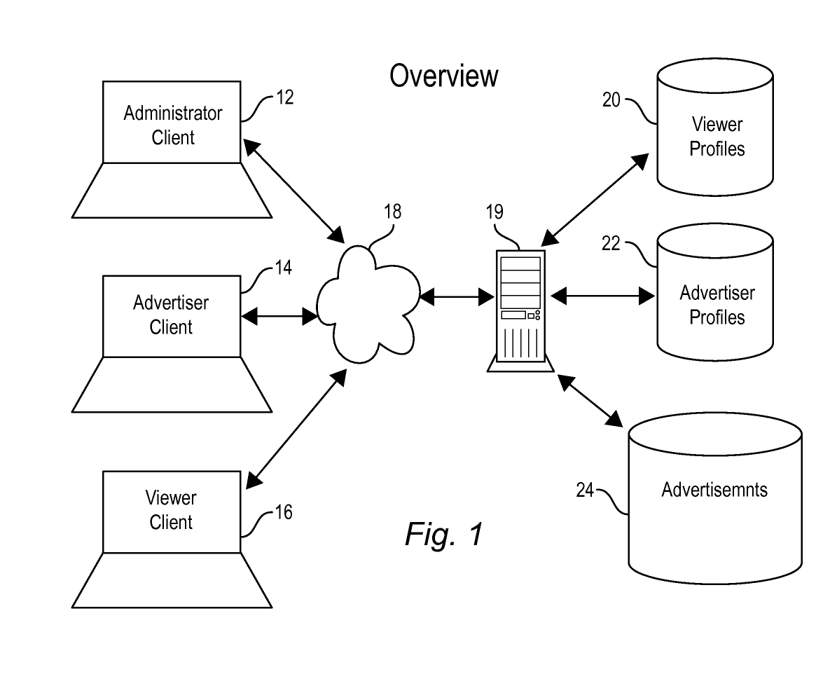

The present inventive concept is directed to a system and process for ranking advertisements for display to at least one viewer. FIG. 1 depicts a block diagram of an embodiment of the system. Disclosed are an administrator client 12, an advertiser client 14, a viewer client 16, a network 18, an application server 19, an advertiser profile database 22, an advertisement database 24, and a viewer profile database 20.

The viewer profile database 20 contains data associated with a system viewer who has entered data corresponding to various viewer preferences, demographics and other viewer data. The advertiser profile database 22 contains data associated with system advertisers who have provided data corresponding to various advertiser preferences, relevant system demographics and other advertising data. In addition, advertisements are associated with various advertiser data and viewer data, including without limitation data relating to viewers' recorded activities, retrievably stored and catalogued in viewer profile database 20 and advertiser profile database 22. Based upon the associated data, the system creates system profiles for permitted use by the system users such as registered viewers and advertisers.

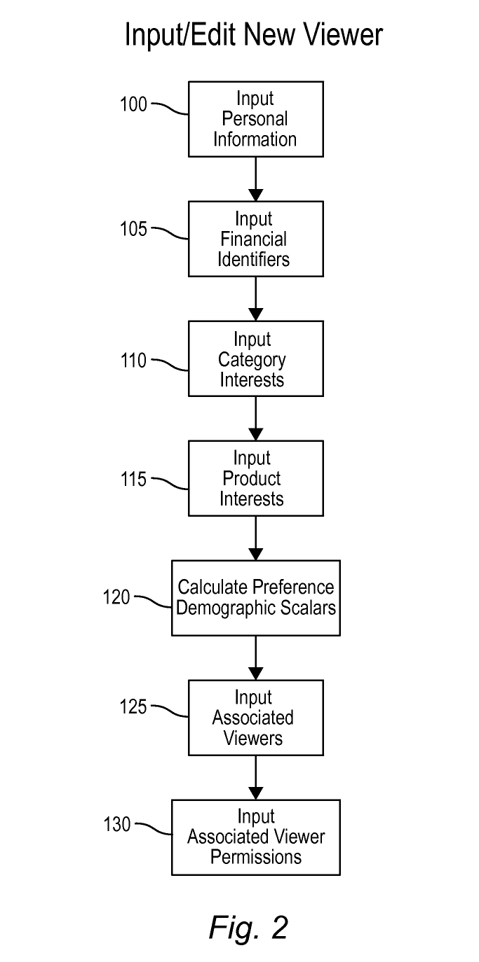

The administrator client 12 or the viewer client 16 may be used to create or edit the viewer data associated with the viewer profile. The flowchart of FIG. 2 illustrates inputting or editing viewer profiles. The viewer inputs information to enable the system to contact him or her, relating to categorization and demographic analysis, and a financial analysis. The viewer inputs personal information such as name, address, email address, telephone, gender, age, birthday, work history, educational background, home ownership status, income, medications, fields of employment, family information, anniversary or other special dates, and the like 100. The viewer also inputs financial information in order to enable the system to complete monetary transfers and tax reporting 105. This can include information such as tax identification numbers, bank account information, online payment systems such as that provided under the trademark PAYPAL®, account preferences, and payment preferences. The viewer also enters additional personal information sufficient to aid the system in performing demographic analysis 120. This may include personal interests, hobbies, sports, social media membership, vacation interests, cultural interests, food preferences, music interests, books read, interesting television shows, outdoor activities, and the like.

The viewer can then input products or product categories of interest 115. The viewer may input broad categories or specific products, such as sporting goods or basketballs. Additionally, the viewer may enter categories or specific products that he or she has purchased, desires to purchase or other purchases of interest.

The system assigns a set of scaled values representing a base preference demographic based on information inputted into the viewer profile or derived from information input into the viewer profile 120. For example, the input scalar may be a scaled number between 0 and 100 based in-part on the viewer's age, geographic, social or demographic information. For example, the system may calculate a humor preference demographic scalar based on the type and numbers of books read input into the viewer profile. The scalar may be greater if more books that the viewer has read are classified as comedies. Conversely, the scalar may be decreased based on the proportion of books read that are classified as dramas, dramas being identified as a category associated with a deduction in humor scalar value. Where suitable, different viewer data may be used to derive a preference demographic scalar. For example, a single humor preference demographic scalar may be based on data for books that the viewer has read and for television shows in which the viewer is interested. The base preference demographic scalars are stored in the viewer profile.

The viewer may select one or more associated viewers 125, from among other users of the system or may input an external reference, e.g. an email address or other identifier associated with the user to be associated with the viewer. The viewer can categorize the associated viewer's connection to the viewer, which may change the associated viewer's access to the viewer profile or otherwise influence the viewer and associated viewer's experience during use of the system. A system interface may be utilized to present a list of other users in the system for selection. Optionally, the list may be filtered. For each listed user, the viewer can select the user to be an associated viewer and the nature of the connection or relationship to the viewer. For example, categories of associated viewers may include, but are not limited to friends, family, acquaintances, work colleagues, and school colleagues. The system may derive a correlation modifier for at least one of the preference demographic scalars using data relating to associated viewers, such as their demographic information or activities. Additionally, the system may provisionally derive data for unavailable or suspect data of a viewer's profile from data of associated viewers. For example, where a viewer's associated viewers have a high humor preference demographic scalar, the system may calculate a correlation modifier for that viewer's humor preference demographic scalar. Additionally, where the income range for the viewer is suspect and there are associated viewers who are related by employer or profession, the system may calculate a correlation modifier for the viewer's income range preference demographic scalar. It is contemplated that similar correlation modifiers may be calculated for modification of other preference demographic scalars or viewer profile data without departing from the spirit of the present inventive concept.

Viewers can associate permissions with their associated viewers 130. Viewers can limit associated viewers' access to personal information, category interests, product interests, and also limit the receipt of communications from associated viewers 130.

Viewer profile information, including the associated viewers 130 and their permissions, is retrievably stored in the viewer profile database 20.

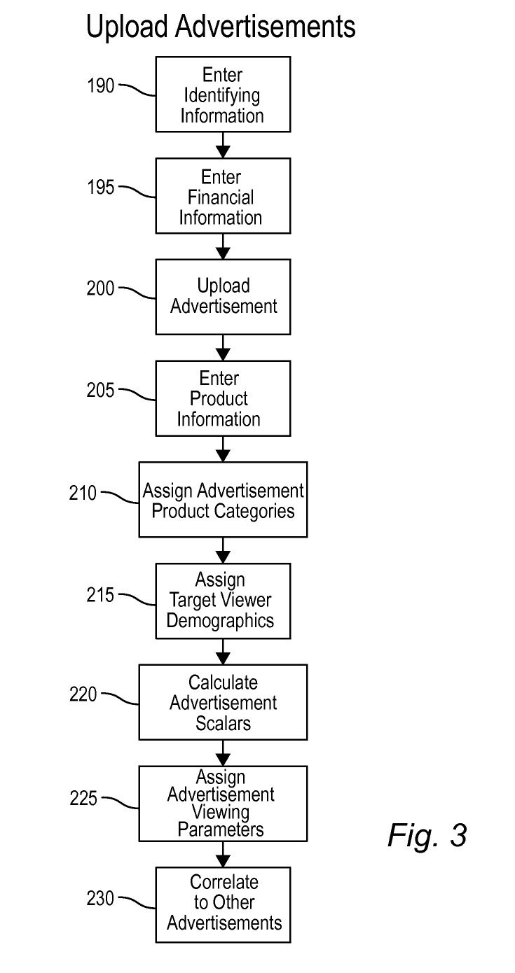

The advertiser client 14 may create, edit or delete the advertiser data associated with advertiser profiles in the database 22 or they may upload videos or other ad content for retrievable storage in the advertisements database 24 and edit or delete ad content retrievably stored in the advertisements database 24. The flowchart of FIG. 3 illustrates uploading advertisements to the system of FIG. 1. The advertiser is prompted to enter identifying information such as entity name, address, email address, telephone, and product categories for storage in the advertiser database 190. The advertiser enters its financial information, such as tax identification numbers, bank account information, online payment systems, such as that provided under the trademark PAYPAL®, account preferences, and payment preferences 195. Using the advertiser provided financial information, the system may effect an initial monetary transfer from the advertiser's account. The system allows for the configuration of multiple advertiser users of any one advertiser profile or client, each having configured permissions and authorized access based upon the configuration parameters stored within the system or communicated to the system. Similarly, multiple administrator users may be allowed access to a given administrator client, with each having configured permissions and authorized access based upon configuration parameters stored within the system or communicated to the system.

The advertiser may also upload, download, edit or delete ads to or within the system 200. The preferred advertisement media format is video, but it may take other formats, such as audio, flash, and animation. The advertiser can input characteristics of the advertisement and the subject product of the advertisement 205. Optionally, the advertiser can generate an electronic coupon to be displayed and/or submitted upon the viewing of the advertisement by a viewer. The advertiser can also select various qualities or characteristics to be associated with the target demography such as, but not limited to, theme, topic, tone, or other characteristics of an advertisement, and may provide subject matter of the advertisement 210 for the system to use in comparing an associated scalar with viewer profile scalars.

As further illustrated in FIG. 3, the advertiser may also provide target viewer demographics to be associated with the advertisement 215 for the purpose of establishing a baseline scalar associated with the ad. In general, the system delivers ads to viewers based upon comparison of scalars associated with a viewer profile against scalars associated with an advertisement and/or the product which is its subject. An advertiser may designate special scalars or parameters associated with advertisement scalars, and such parameters may include targeted viewer age ranges, targeted viewer income ranges, or targeted viewer education level, targeted viewer gender, targeted viewer social status, profession, targeted viewer hobbies, or other parameters configured within the system for selection by the advertiser.

The system calculates a set of scaled values representing product scalars and advertisement scalars based on inputted advertisement information, and a set representing viewer-associated scalars based on information input into the viewer profile 220. For example, one input scalar may be a number between 0 and 100 representing a desired viewer income range. Another example might be an adventure advertisement scalar with a value adjusted by the presence of the word “tiger” in the advertisement data. The system may combine different pieces of information or input scalars to calculate a base product scalar or a base advertisement scalar. By using a scalar between 0 and 100, the system allows for better matching of advertisements to appropriate viewers.

Scalars can be placed in various categories like comedy, drama, sports, and food. Each scalar may represent a weighted value within each category. For example, a scalar of 56.3 may correspond to pizza while a scalar of 5 may represent Chinese food, with each being in the food category. Organizing products and advertisements into categories can also be useful for searching by the viewer of the advertisement database.

Products may also be categorized using a scale method, with products within each category being associated with discrete system scalars. In this way, the system can evaluate every viewer to determine which advertisements to associate with each user based upon the relevant category value as well as to determine which products correspond for the purposes of providing additional marketing/advertising opportunities. Additionally, the system correlates the advertisement to other advertisements in the system 230. The system may normalize the product scalars and advertisement scalar relative to other advertisements. For example, the scalars of similar products or product categories may be normalized Likewise, the scalars of advertisements with similar themes may be normalized.

The advertiser may further provide additional financial parameters for the advertisement 225, as indicated in FIG. 3. The parameters including, but not being limited to compensation per view, daily viewing limits, or daily budget limits.

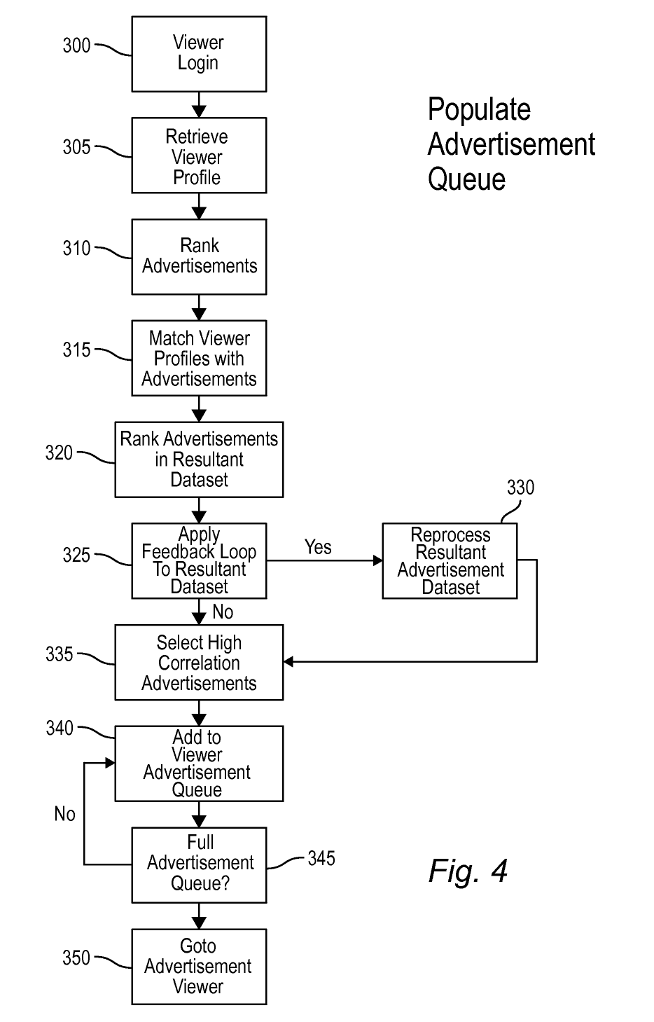

The system generates a queue of mandatory advertisements and permissive advertisements associated with a viewer profile so that when a viewer logs into the system, the queue is displayed. Permissive advertisements may also be added by the viewer or by associated viewers as discussed further herein. Queues are arranged so that the mandatory advertisements are viewed prior to other advertisements during paid viewing. FIG. 4 illustrates the process for populating the mandatory portion of the queue for a viewer. The illustrated trigger event is viewer login 300. However, the trigger event may be creation of a new viewer profile, editing a viewer profile, periodic time intervals, uploading a new advertisement, viewing an advertisement, editing an advertisement, or other events without departing from the spirit of the present inventive concept. If viewer login is used, after login the system retrieves the viewer's profile 305.

The system determines a number of advertisements to be displayed. One method of doing this is by ranking 310 the advertisements by product, target demographic, and advertising information. The system compares the viewer profile and advertisements in the advertisement database and related scalars to produce a resultant data set 315. The system compares the viewer profile information with the corresponding information from the advertisements, using input information as well as derived information and scalars where suitable. For example, the income scalar associated with the viewer profile may be compared with the target income scalar associated with the advertisement and any parameters entered by the advertiser, the humor scalar associated with the viewer profile may be compared with the humor scalar generated by the system and associated with various advertisements, and the preferred match may be determined and displayed. The system may display advertisements associated with a product of interest as indicated within the viewer profile or as otherwise determined to be a product of interest e.g. by computing a product of interest scalar and determining an association between the product of interest scalar and other product scalars. These comparisons result in a resultant data set which drives ordering of advertisements in the viewer profile. Because the data set includes data associated with the compared advertisements which are to be placed in order, the data set itself may be edited to reflect the desired order of advertisements.

The system orders the advertisements using the resultant data set. The comparison from which the data set is derived may involve comparing the difference between corresponding scalars. For example, the difference between a humor preference demographic scalar associated with the viewer profile and a humor theme scalar associated with the advertisement information is calculated. A small difference indicates a high correlation or preferable match. The resultant data set may be used to order advertisements according to the difference between a primary scalar pair representing a first key, the difference between a secondary scalar pair representing a second key, and so on until the number of desired scalar pairs is exhausted. Alternatively, the sum of the difference between all the scalars pairs of concern is calculated for the sorting key. In yet another embodiment, the preceding two approaches are blended by selecting scalar pair differences to be calculated for individual keys and selecting other scalar pair differences to be totaled for an aggregate single sorting key.

It should be noted that the weight of the scalars can be adjusted for optimum ordering to adjust for relative importance. The scale may also be altered for given input data or the difference between corresponding scalars may be manipulated without departing from the spirit of the present inventive concept.

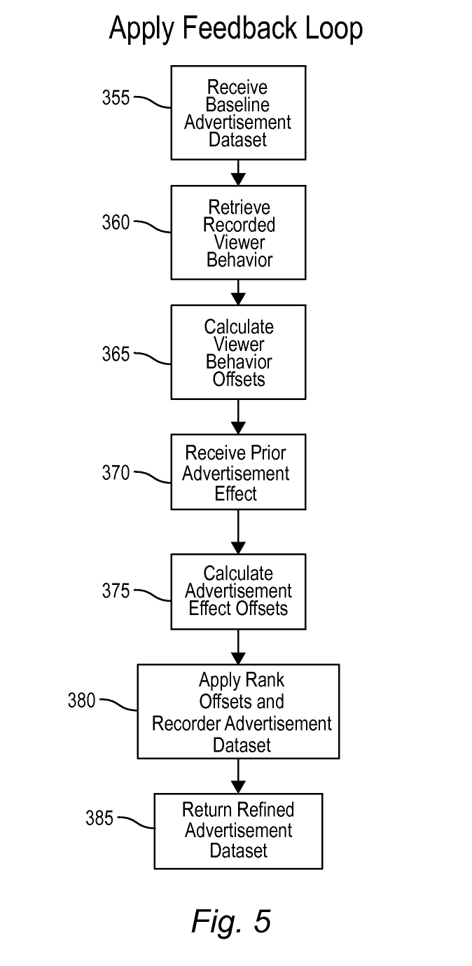

Optionally, the system can further refine the ordering of advertisements using feedback from prior use of the system 325. If the system applies additional processing of the resultant data set with feedback from prior system use, the process of FIG. 5 may be employed as further disclosed below.

Still referring to FIG. 4, if the mandatory portion of the viewer queue is not full, at least one advertisement from the resultant data set of step 320 or 330 is selected for placement in the mandatory portion of the viewer queue 335. If the viewer advertisement queue is not full 340 thereafter, the system iteratively selects more advertisements for placement in the viewer's mandatory portion of the queue. If it is full, the system advances the viewer to the advertisement viewer 350.

The viewer's interface preferably presents at least three display panels, namely a display panel 405, a social control panel 410, and a user information panel 415. These may optionally be displayed simultaneously, and unused panels may be replaced with active content including by expanding or including other panels.

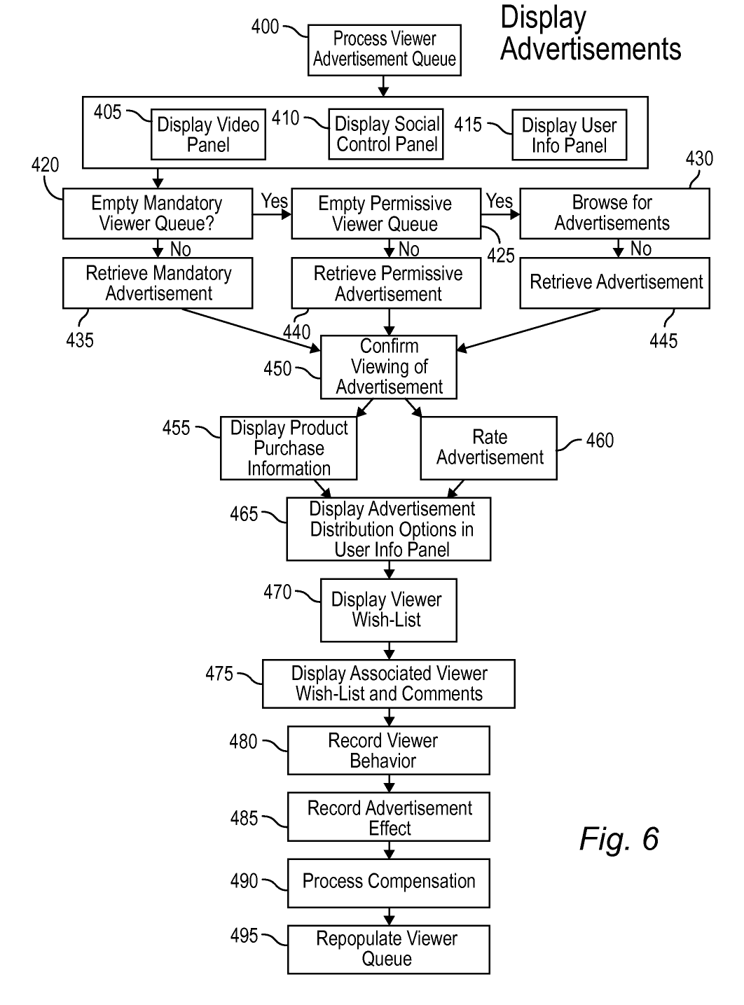

As illustrated in FIG. 6 in connection with viewing to be evaluated for compensation, the system determines whether the mandatory portion of the viewer queue is empty 420. If the mandatory portion of the viewer queue currently lists an unwatched advertisement, the system retrieves and directs the unwatched advertisement from the top of that queue to the display video panel 435. If the mandatory portion of the viewer queue is empty, the system checks the permissive portion of the viewer queue for pending permissive advertisements 425. If the permissive portion of the viewer's queue contains an unwatched advertisement, the system retrieves and directs the unwatched advertisement from the top of that queue to the display video panel 440. If the permissive viewer portion of the queue is empty 430, the viewer may browse the advertisement database and select any advertisement for retrieval and direction to the display panel 445. Of course, a viewer may at any time browse for advertisements, for example using a search tool employing key word search technology or categorical associations, to view without completing the mandatory and permissive advertisements in the queue without being compensated, for example if the viewer wishes to search for advertisements that might contain coupons.

The viewer interface is configured to provide quality viewing results through selected viewing confirmation for each displayed advertisement 450. Several approaches may be employed to assure viewing using confirmation. One way is to limit the length of the advertisement such that it is consistent with an indication that the viewer has viewed the advertisement. The preferable maximum length under this approach is fifteen seconds. Another way for confirming viewing of the advertisement is to require interaction with the advertisement, such as with a video, at select points. The system would require the viewer to provide input during the advertisement display in order for the video to advance or upon conclusion. A third way to confirm viewing and improve focus during display of the advertisement is to poll the viewer after the advertisement, preferably with a question relating to its content, but alternatively using any other input supplied at the conclusion of the video.

On successful completion of the advertisement, the viewer interface may simultaneously display product purchase information for the subject of the advertisement in the user information panel 455, feedback or rating options for the advertisement in the video panel 460, and/or various other tools for sharing or communicating the advertisement with others such as associated viewers.

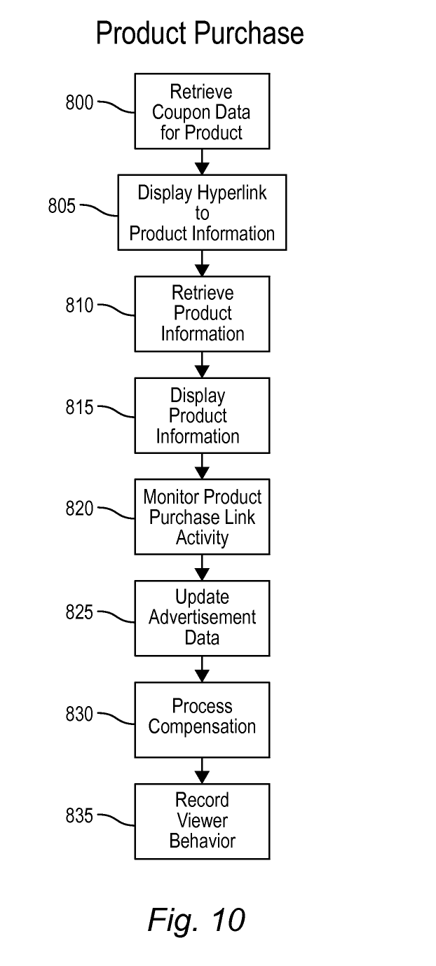

FIG. 10 illustrates a process for display of product purchase information 455 (FIG. 6) in association with the user panel. The system first retrieves any coupon pricing for the product 800 provided by the advertiser in connection with the upload of advertisement data. The system will also provide purchase information such as a link within the user panel allowing the viewer to purchase the subject product 805. The link may be embedded with identifying data so that third party vendors can credit the system when the link is activated. The system then retrieves the product information associated with the advertisement 810. The product information is displayed to the viewer 815. The interface monitors the viewer behavior 820. Monitored behaviors can include actions such as activation of the product purchase link, failure to activate the product purchase link, and the time the viewer keeps the screen active. This data regarding the viewer's behavior is recorded 825 in both the viewer profile database and the advertisement database to provide back to the merchant in the form of feedback and for adjusting the scalars associated with the viewer and/or the advertisement. In the case of a viewer product purchase, the system records the information for possible compensation 830.

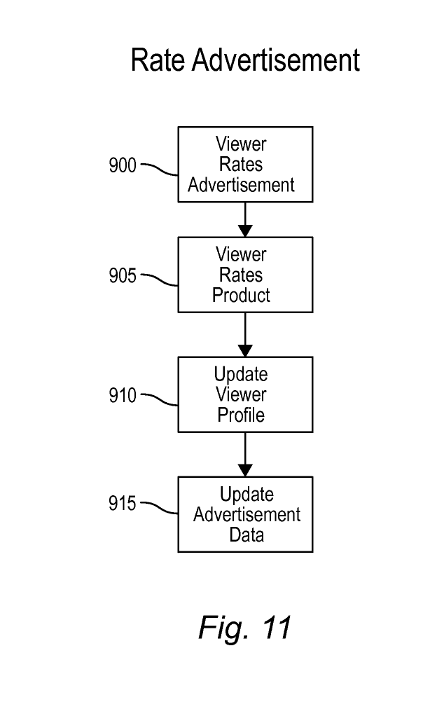

FIG. 11 shows the rating of an advertisement according to an embodiment of the present inventive concept. The viewer is presented with a series of rating options relating to the advertisement and the product therein. The viewer may rate the advertisement as a whole, selecting from ratings such as: bad, indifferent, good, or great. The viewer may also rate different traits or elements of the advertisement 900, such as humor or entertainment value. The viewer may also rate 905 the subject matter of the advertisement, e.g., a product contained therein. The system updates the viewer profile and the advertisement data for additional processing 910, 915 according to viewer's rating. In a preferred embodiment, the option to rate the advertisement is incentivized through a resulting decrease in time between display of advertisements. For example, where a viewer may otherwise be required to wait a certain period of time between viewing advertisements, the viewer may instead rate a first advertisement to accelerate initiation of display of a second advertisement, thus incentivizing the viewer to participate in rating.

After interaction with the product purchase interfaces 455 and advertisement rating 460, as described in more detail respectively in connection with FIGS. 10 and 11, the viewer may continue the process for displaying advertisements. Referring back to FIG. 6, the viewer is presented the option to distribute the advertisement using the system to another user, such as associated viewers 465 including those previously selected or new associated viewers to be added, with the foregoing being associated with the viewer for retrievable storage by the system.

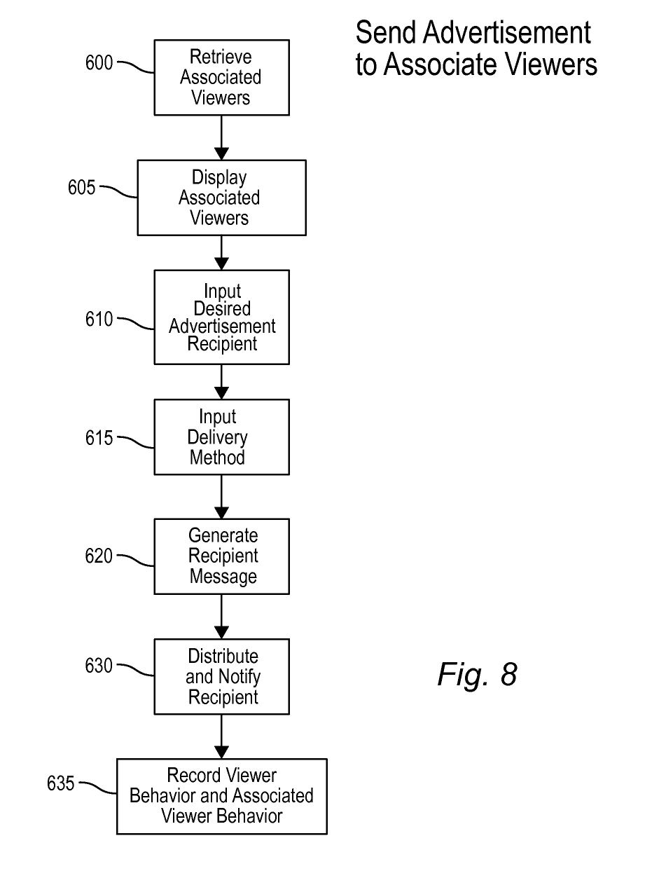

FIG. 8 illustrates advertisement distribution 465 according to the present inventive concept. Initially, the system retrieves 600 associated viewers from the viewer profile. The system filters associated viewers who do not accept receipt of advertisements and displays the remaining associated viewers 605. The viewer selects 610 the target recipients for delivery of the advertisement. Next, the viewer selects the method of delivery 615 or relies on a system default method of delivery. The viewer may choose a method within the system, such as display on the recipient associated viewer's information panel, and the subject video is added to the recipient's permissive queue. Alternatively, the viewer may select a method for notification external to the system, such as email. The system could also be configured to retrieve and send emails from/to an email server using standard email protocols like pop3 or imap. The viewer may personalize the message for the system generated email notification 625. The system then transmits the message and notifies the recipient 630 of the advertisement. The system records 635 the viewer's action in sending the advertisement and the recipient's interaction with the advertisement for additional processing.

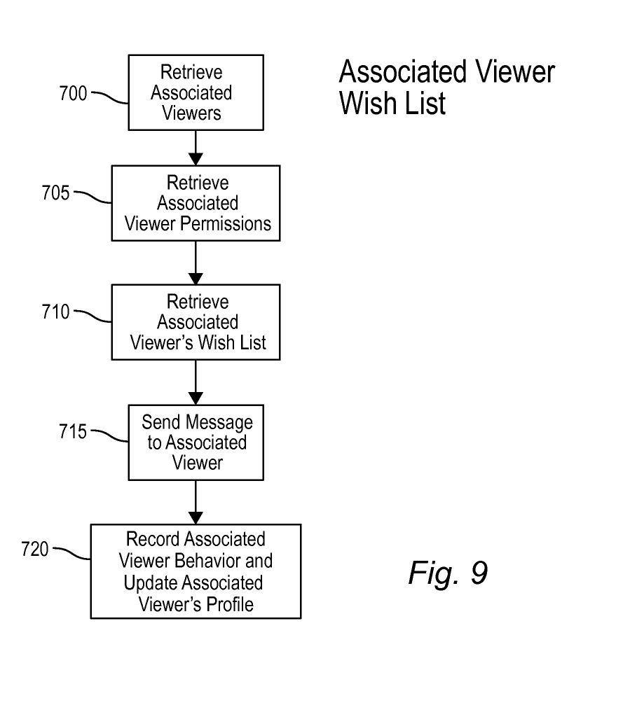

The viewer may be presented the option to add the product of the advertisement to a wish list 470 and/or to suggest that an associated viewer add the product to his or her wish list 475. In the case of a viewer adding the subject product to his own wish list, the product is retrievably stored within a database associated with the viewer's profile along with a record of the viewer's action in wish-listing the product. FIG. 9 shows the process for suggesting the product to an associated viewer. The system retrieves the list of associated viewers from the viewer's profile 700. The system then retrieves the permissions associated with each associated viewer 705. The associated viewers who have chosen not to receive such suggestions are filtered from the list. The system then retrieves the current product wish list of each associated viewer for comparison to the current product 710. The associated viewers with the subject product already in their wish list are also filtered from the list. The interface displays the filtered list to the viewer, where the viewer may select recipients and/or personalize the suggestion 715. The viewer suggestion and the recipients' interaction with the message are recorded in the viewer profiles and advertisement data 720.

Referring back to FIG. 6, to the extent viewer behavior and advertisement effect data has not already been recorded in steps for displaying product information 455, rating advertisements 460, advertisement distribution 465, and displaying wish-lists 470, 475, it is recorded in steps 480 and 485. This information may be used to further refine ranking of advertisements, and provide a feedback loop for better matches of viewers with advertisements. The system optionally applies this feedback information to populate a viewer queue 325.

Referring to FIG. 5, the baseline resultant data set is received 355. The system retrieves the viewer's recorded behavior data 360, which includes data collected and retrievably stored over time relating to the viewer's interactions with the system. The data is parsed and the viewer's past ratings, advertisement distribution, and wish list products are analyzed with data relating to advertisement products and advertisement content that the viewer previously acted upon. The system analyzes those actions to refine the preference demographic scalars. For example, where a viewer input indicating an interest in outdoor activities is processed alongside negative ratings for advertisements with outdoor activity themes, the system can adjust the outdoor activity preference demographic scalar. The system calculates an offset for adjusting scalar(s) related to the recorded viewer behavior 365.

The viewer's recorded behavior data may be associated with the advertisements 370. That data is parsed and the advertisement's past ratings, advertisement distribution, and subject products are processed in respect to its effect upon viewers. The system analyzes those effects to refine the product scalars and advertisement scalars. For example, where an advertiser selects a dramatic theme for an advertisement but a plurality of viewers rate the advertisement theme as humorous, the system can adjust the theme advertisement scalar. The system calculates an offset for adjusting the scalar(s) related to the recorded advertisement effect 375.

The system applies the offset(s) 380 to the viewer profile scalar(s), the product scalar(s), and the advertisement scalar(s) of the data set received in step 355. The data set is reordered accordingly, and the new feedback-refined data set is returned for use in selection of advertisements for the viewer queue 335.

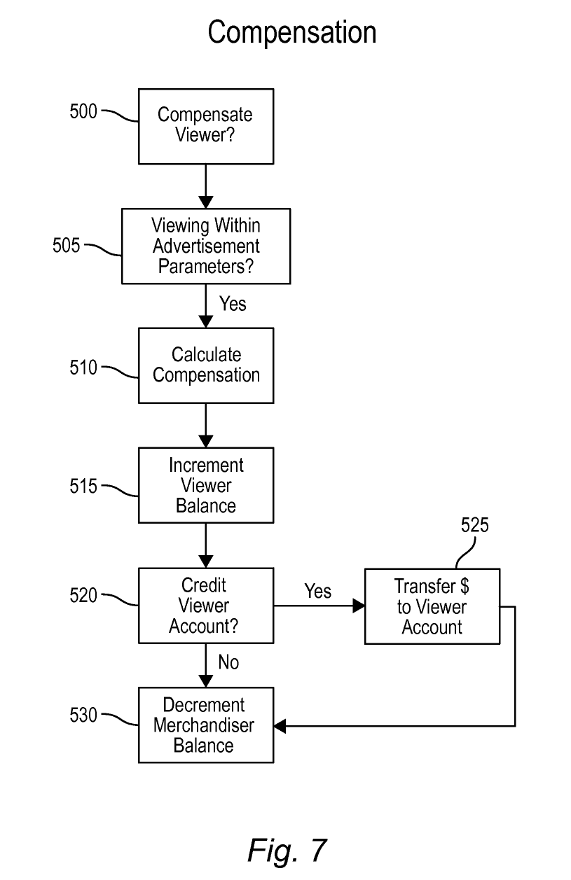

Finally, referring to FIG. 7, a viewer is illustrated being compensated 500 after an advertisement is viewed. Determination of whether to credit a viewer and how much to credit a viewer can include a number of factors. Factors may include determining an entrance event associated with the viewed advertisement and the advertisement parameters 505. The entrance event to the advertisement may be through the viewer's permissive queue or browsing, and the system may determine that no compensation is due and notify the viewer of that, providing an updated viewer account balance display. If the viewed advertisement was retrieved from the mandatory queue, the system may verify that the viewer daily credit has not exceeded the system's daily limit and if not, credit the viewer's account accordingly.

Advertisements may be placed in the mandatory queue in part by evaluating whether such placement would cause the advertisement to exceed parameters input with upload of the advertisement, such as the daily budget, display limits, or the like. In addition, if a bonus or other credit was associated with the viewing of the advertisement as configured by the advertiser during input of the advertisement, the system may generate a preference factor for the advertisement giving more weight to advertisement for purposes of ordering in the viewer queue. The advertisement may include a bonus associated with the viewing of the advertisement, which would allow the viewer to receive additional credit for viewing the advertisement. In that case, the bonus associated with the viewing of the advertisement would be added to the viewer credit balance.

The system calculates the compensation due if the viewing was within the advertisement parameters 510 and increments the viewer account balance 515. Advertisement parameters may relate to the manner in which the advertisement must be watched for compensation to be awarded, such as a requirement to interact with the advertisement at certain times within its display to ensure attentiveness. The system makes a determination as to whether viewer credit balance should be transferred to the viewer 520. Preferably transfers which are to be made are held until a threshold such as a minimum account value or minimum time period is reached. If a threshold is reached, the viewer account balance is transferred to the preferred account stored in the viewer's profile 525. The advertiser's account is correspondingly decremented 530. The viewer's account balance may also be displayed.

Compensation may be flighted within or across the different categories of advertisements. The fighting may be related to the amount compensated for a given advertisement and/or to whether compensation is to be had for a given advertisement. For example, watching mandatory advertisements may involve compensation for each advertisement watched, watching the first five permissive advertisements that follow may involve compensation for three out of the five advertisements with notification as to compensation for each advertisement occurring following its display, watching the second five permissive advertisements that follow may involve compensation for one out of the five advertisements, with additional advertisements watched during that day going uncompensated Likelihood or amount of compensation for viewing any given advertisement may drop off with the number of advertisements watched as a way of controlling prolonged and presumably less attentive advertisement watching.

The system may also link to and/or may retrievably store other, non-advertisement media, for use in connection with the advertisements. For example, a user may be offered the option to link to or otherwise view a movie, provided that such a user must first view one or more advertisements. If viewing of advertisements is linked with viewing of other media, information regarding such other media is preferably recorded for analysis and retrievable storage in association with the user and with the associated advertisement(s). For example, repeated selection by the user of movies having a humorous theme will be recorded behavior which may be utilized to adjust scalars computed by the system.

The methods and systems described herein may be deployed in part or in whole through a machine, including without limitation the application server 19 of FIG. 1, that executes computer software on a server, client, firewall, gateway, hub, router, or other such computer and/or networking hardware. Such computer software may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network 18. The networking of some or all of these devices may facilitate parallel processing of a program or method at one or more location without deviating from the scope of the inventive concept. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

Software programs may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The system, methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, 4G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music users and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipments, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes or functions may be realized as a computer executable code capable of being executed on a machine readable medium.

Computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

Having now described the features, discoveries and principles of the general inventive concept, the manner in which the general inventive concept is constructed and used, the characteristics of the construction, and advantageous, new and useful results obtained; the new and useful structures, devices, tools, elements, arrangements, parts and combinations, are set forth in the appended claims.

It is also to be understood that the following claims are intended to cover all of the generic and specific features of the general inventive concept herein described, and all statements of the scope of the general inventive concept which, as a matter of language, might be said to fall therebetween.

What is claimed is:

1. A method of delivering one or more mandatory advertisements for presentation to a viewer, the method comprising the steps of:
generating a data set by comparing information associated with a viewer profile of the viewer to information associated with a plurality of advertisements;
selecting one or more mandatory advertisements from among the plurality of advertisements based on the data set;
populating a viewer queue with the one or more mandatory advertisements; and
delivering the one or more mandatory advertisements to the viewer.

2. The method of claim 1,
wherein the information associated with the plurality of advertisements includes information regarding at least one of (i) characteristics of at least one of the plurality of advertisements, (ii) a product or service associated with at least one of the plurality of advertisements, (iii) preferences of at least one advertiser associated with at least one of the plurality of advertisements, and (iv) preferences of at least one user.

3. The method of claim 1,
wherein,
the information associated with the viewer profile includes a preference demographic scalar,
the information associated with the plurality of advertisements includes an advertisement scalar for each of the plurality of advertisements, and
the data set includes data resulting from a comparison of the preference demographic scalar with the advertisement scalar.

4. The method of claim 1,
wherein,
the information associated with the viewer profile includes a preference demographic scalar,
the information associated with the plurality of advertisements includes a product scalar for each of the plurality of advertisements, and
the data set includes data resulting from a comparison of the preference demographic scalar with the product scalar.

5. The method of claim 1,
wherein,
the information associated with the plurality of advertisements includes target viewer demographics for one or more of the plurality of advertisements, and
the data set includes data resulting from a comparison of the information associated with the viewer profile with the target viewer demographics.

6. The method of any of claims 3-5,
wherein,
the information associated with the plurality of advertisements further includes a parameter for one or more of the plurality of advertisements, and
the data set further includes data resulting from a comparison of the information associated with the viewer profile with the parameter.

7. The method of either of claims 3 and 4,
wherein the information associated with the plurality of advertisements is normalized based on advertisements other than the plurality of advertisements.

8. The method of claim 1,
wherein,
the information associated with the viewer profile includes a product of interest selected by the viewer,
the information associated with the plurality of advertisements includes information regarding products or services associated with the plurality of advertisements, and
the data set includes data resulting from a comparison of the product of interest with information regarding products or services associated with the plurality of advertisements.

9. The method of claim 1, further comprising the steps of:
displaying a first advertisement of the one or more mandatory advertisements for viewing by the viewer; and
confirming the first advertisement was viewed by the viewer via generation of a data-input request delivered to the user during or following the displaying of the first advertisement.

10. The method of claim 1, further comprising the steps of:
displaying a first advertisement of the one or more mandatory advertisements for viewing by the viewer; and
prompting the viewer to input a response to a data-input request transmitted to the user following the displaying of the first advertisement, the data-input request (i) based on the first advertisement and (ii) configured to confirm viewing of the first advertisement by the viewer.

11. The method of claim 1, further comprising the steps of:
displaying a first advertisement of the one or more mandatory advertisements for viewing by the viewer;
requesting that the viewer submit a rating of the first advertisement; and
displaying a second advertisement for viewing by the viewer upon receipt of a response from the user to the request that the viewer submit the rating of the first advertisement,
wherein,
the displaying of the second advertisement is expedited if the response from the user contains the rating of the first advertisement, and
the displaying of the second advertisement is delayed if the response from the user does not contain the rating of the first advertisement.

12. The method of claim 1, further comprising the step of:
providing the viewer with the option to select another person to whom the one or more mandatory advertisements may be forwarded for display to the another person.

13. The method of claim 12, wherein the another person is an associated viewer.

14. The method of claim 12, wherein an identifier is configured to (i) identify the another person to the viewer and (ii) cause the one or more mandatory advertisements to be delivered to the another person.

15. The method of claim 14, further comprising the step of:
associating the one or more mandatory advertisements to a message provided by the viewer configured to be forwarded to the another person.

16. The method of claim 1, further comprising the steps of:
displaying a first advertisement of the one or more mandatory advertisements for viewing by the viewer; and
presenting an option to the viewer configured to allow the viewer to add a product associated with the first advertisement to a wish list.

17. The method of claim 16, wherein the wish list is associated with an associated viewer.

18. The method of claim 1, further comprising the steps of:
calculating an offset based on recorded viewer behavior data; and
applying the offset to the data set to adjust the data included in the data set before selection of the one or more mandatory advertisements.

19. The method of claim 1, further comprising the steps of
displaying a first advertisement of the one or more mandatory advertisements for viewing by the viewer; and
determining whether compensation is to be awarded to the viewer for viewing the first advertisement.

20. The method of claim 19, wherein the determining of whether compensation is to be awarded includes determining an entrance event and determining whether the viewer complied with advertisement parameters.

21. The method of claim 19, wherein the compensation to be awarded is flighted.

22. The method of claim 1, further comprising the step of:
providing the viewer with the option to select one or more associated viewers from among other users.

23. The method of claim 22, further comprising the steps of:
deriving a correlation modifier from information associated with viewer profiles of the selected one or more associated viewers; and
applying the correlation modifier to the viewer's viewer profile.

24. The method of claim 22, further comprising the steps of:
providing the viewer with an option to select one or more categories with which any of the selected one or more associated viewers may be associated; and
providing the viewer with an option to limit access by the one or more associated viewers to only a portion of the information associated with the viewer profile by selecting from among the one or more associated viewers individually, or by selecting them by the one or more categories.

25. The method of claim 1, further comprising the step of:
providing the viewer with access to a search tool configured to allow the viewer to search for and select one or more permissive advertisements.

26. The method of claim 1, wherein at least one of the one or more mandatory advertisements is associated with a coupon.
